(19) United States
(12) Patent Application Publication
(10) Pub. No.: US 2025/0374368 A1
(43) Pub. Date: Dec. 4, 2025

(54) COMMUNICATION METHOD AND RELAY APPARATUS

(71) Applicant: KYOCERA Corporation, Kyoto (JP)

(72) Inventor: Masato FUJISHIRO, Yokohama-shi (JP)

(73) Assignee: KYOCERA Corporation, Kyoto (JP)

(21) Appl. No.: 19/300,389

(22) Filed: Aug. 14, 2025

Related U.S. Application Data
(63) Continuation of application No. PCT/JP2024/004849, filed on Feb. 13, 2024.

(30) Foreign Application Priority Data
Feb. 15, 2023 (JP) 2023-021686

(51) Int. Cl. H04W 76/27

(52) U.S. Cl. CPC H04W 76/27

(57) ABSTRACT

A communication method used in a relay apparatus including a relay device configured to perform a relay operation of relaying a radio signal transmitted between a network and a user equipment, and a control terminal configured to receive a control signal used for control of the relay device from the network, the communication method including the steps of: receiving, by the control terminal in a radio resource control (RRC) connected state, an RRC Reconfiguration message from the network; and turning off the relay device configured to perform the relay operation for a serving cell of the control terminal, when changing or deactivating the serving cell based on the RRC reconfiguration message.

### RELATED APPLICATIONS

The present application is a continuation based on PCT Application No. PCT/JP2024/004849, filed on Feb. 13, 2024, which claims the benefit of Japanese Patent Application No. 2023-021686 filed on Feb. 15, 2023. The content of which is incorporated by reference herein in their entirety.

### TECHNICAL FIELD

The present disclosure relates to a communication method and a relay apparatus used in a mobile communication system.

### BACKGROUND

In recent years, a mobile communication system of the fifth generation (5G) has been attracting attention. New Radio (NR), which is a radio access technology of the 5G system, is capable of wide-band transmission via a high frequency band as opposed to Long Term Evolution (LTE), which is a fourth-generation radio access technology.

Since radio signals (radio waves) in the high frequency band such as a millimeter wave band or a terahertz wave band have high rectilinearity, reduction of coverage of a base station is a problem. In order to solve such a problem, a repeater apparatus that is a type of relay apparatus relaying radio signals between the network and a user equipment and can be controlled from a network is attracting attention (see, for example, Non-Patent Literature 1). Such a repeater apparatus can extend the coverage of the base station while suppressing occurrence of interference by, for example, amplifying a radio signal received from the base station and transmitting the radio signal through directional transmission. Such a repeater apparatus is referred to as a network-controlled repeater (NCR).

### CITATION LIST

### Non-Patent Literature

Non-Patent Literature 1: 3GPP Contribution: RP-213700, “New SI: Study on NR Network-controlled Repeaters”

### SUMMARY

A communication method according to a first aspect is a communication method used in a relay apparatus including a relay device configured to perform a relay operation of relaying a radio signal transmitted between a network and a user equipment, and a control terminal configured to receive a control signal used for control of the relay device from the network, the communication method including: receiving, by the control terminal in a radio resource control (RRC) connected state, an RRC Reconfiguration message from the network; and turning off the relay device configured to perform the relay operation for a serving cell of the control terminal, when changing or deactivating the serving cell based on the RRC Reconfiguration message.

A relay apparatus according to a second aspect includes a relay device configured to perform a relay operation of relaying a radio signal transmitted between a network and a user equipment, and a control terminal configured to receive a control signal used for control of the relay device from the network, in which the control terminal: receives a radio resource control (RRC) Reconfiguration message from the network in an RRC connected state; and turns off the relay device configured to perform the relay operation for a serving cell of the control terminal, when the serving cell is changed or deactivated based on the RRC Reconfiguration message.

### BRIEF DESCRIPTION OF THE DRAWINGS

FIG. 1 is a diagram illustrating a configuration of a mobile communication system according to an embodiment.

FIG. 2 is a diagram illustrating a configuration of a protocol stack of a radio interface of a user plane handling data.

FIG. 3 is a diagram illustrating a configuration of a protocol stack of a radio interface of a control plane handling signaling (control signal).

FIG. 4 is a diagram illustrating an example of an application scenario of an NCR apparatus (relay apparatus) according to a first embodiment.

FIG. 5 is a diagram illustrating an example of an application scenario of the NCR apparatus according to the first embodiment.

FIG. 6 is a diagram illustrating an example of a method of controlling an NCR apparatus according to the first embodiment.

FIG. 7 is a diagram illustrating an example of a configuration of a protocol stack in a mobile communication system having the NCR apparatus according to the first embodiment.

FIG. 8 is a diagram illustrating a specific example of a configuration of a mobile communication system having the NCR apparatus according to the first embodiment.

FIG. 9 is a diagram illustrating an example of a configuration of the NCR apparatus according to the first embodiment.

FIG. 10 is a diagram illustrating a configuration of a user equipment (UE) according to the embodiment.

FIG. 11 is a diagram illustrating an example of a configuration of a gNB (base station) according to the embodiment.

FIG. 12 is a diagram illustrating an example of an operation scenario according to the first embodiment.

FIG. 13 is a diagram illustrating an example of an operation according to the first embodiment.

FIG. 14 is a diagram illustrating an example of an operation scenario according to a first variation of the first embodiment.

FIG. 15 is a diagram illustrating an example of an operation according to the first variation of the first embodiment.

FIG. 16 is a diagram illustrating dual connectivity (DC).

FIG. 17 is a diagram illustrating an example of an operation scenario according to a second variation of the first embodiment.

FIG. 18 is a diagram illustrating an example of an operation according to the second variation of the first embodiment.

FIG. 19 is a diagram illustrating an example of an operation according to a third variation of the first embodiment.

FIG. 20 is a diagram illustrating a RIS apparatus (relay apparatus) according to a second embodiment.

FIG. 21 is a diagram illustrating a RIS apparatus according to the second embodiment.

### DESCRIPTION OF EMBODIMENTS

A mobile communication system according to an embodiment is described with reference to the drawings. In the description of the drawings, the same or similar parts are denoted by the same or similar reference signs.

### (1) First Embodiment

A first embodiment will be described. A relay apparatus according to an embodiment is a repeater apparatus (that is, an NCR apparatus) that can be controlled from a network.

### (1.1) Overview of Mobile Communication System

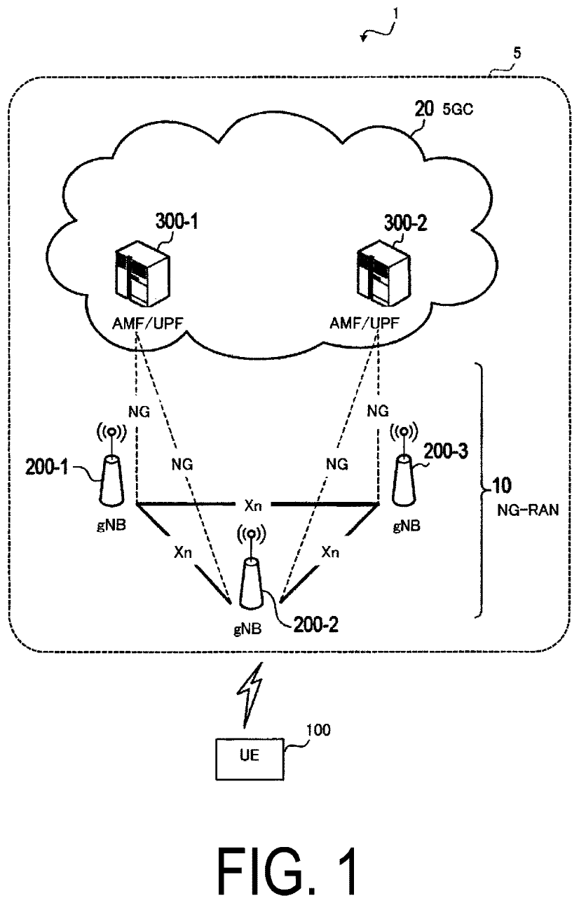

FIG. 1 is a diagram illustrating a configuration of a mobile communication system according to an embodiment.

The mobile communication system 1 complies with the 5th Generation System (5GS) of the 3rd Generation Partnership Project (3GPP) (registered trademark; the same applies hereinafter). Hereinafter, 5GS will be described by way of example, but a long term evolution (LTE) system may be at least partially applied to the mobile communication system. Alternatively, a sixth generation (6G) system may be at least partially applied to the mobile communication system.

The mobile communication system 1 includes a user equipment (UE) 100, a 5G radio access network (NG-RAN: Next Generation Radio Access Network) 10, and a 5G core network (5GC: 5G Core Network) 20. Hereinafter, the NG-RAN 10 may be simply referred to as a RAN 10. The 5GC 20 may be simply referred to as a core network (CN) 20. The RAN 10 and the CN 20 constitute a network 5 of the mobile communication system 1.

The UE 100 is a mobile wireless communication apparatus. The UE 100 may be any apparatus as long as the UE 100 is used by a user. Examples of the UE 100 include a mobile phone terminal (including a smartphone) and/or a tablet terminal, a notebook PC, a communication module (including a communication card or a chipset), a sensor or an apparatus provided on a sensor, a vehicle or an apparatus provided on a vehicle (Vehicle UE), and a flying object or an apparatus provided on a flying object (Aerial UE).

The NG-RAN 10 includes a base station (referred to as “gNB” in the 5G system) 200. The gNBs 200 are interconnected via an Xn interface which is an inter-base station interface. Each gNB 200 manages one or more cells. The gNB 200 performs wireless communication with the UE 100 that has established a connection to the cell of the gNB 200. The gNB 200 has a radio resource management (RRM) function, a function of routing user data (hereinafter simply referred to as “data”), a measurement control function for mobility control and scheduling, and the like. The “cell” is used as a term representing a minimum unit of a wireless communication area. The “cell” is also used as a term representing a function or a resource for performing wireless communication with the UE 100. One cell belongs to one carrier frequency (hereinafter, simply referred to as a “frequency”).

The gNB 200 may be functionally divided into a central unit (CU) and a distributed unit (DU). The CU controls the DU. The CU is a unit including upper layers included in a protocol stack described below, such as an RRC layer, an SDAP layer, and a PDCP layer, for example. The CU is connected to a core network via an NG interface which is a backhaul interface. The CU is connected to an adjacent base station via the Xn interface, which is an inter-base station interface. The DU forms a cell. The DU 202 is a unit including lower layers included in the protocol stack described below, such as an RLC layer, a MAC layer, and a PHY layer, for example. The DU is connected to the CU via an F1 interface which is a fronthaul interface.

The gNB can be connected to an evolved packet core (EPC) corresponding to a core network of LTE. An LTE base station can also be connected to the 5GC. The LTE base station and the gNB can be connected via an inter-base station interface.

The 5GC 20 includes an access and mobility management function (AMF) and a user plane function (UPF) 300. The AMF performs various types of mobility controls and the like for the UE 100. The AMF manages mobility of the UE 100 by communicating with the UE 100 by using Non-Access Stratum (NAS) signaling. The UPF controls data transfer. The AMF and UPF are connected to the gNB 200 via an NG interface which is an interface between a base station and the core network.

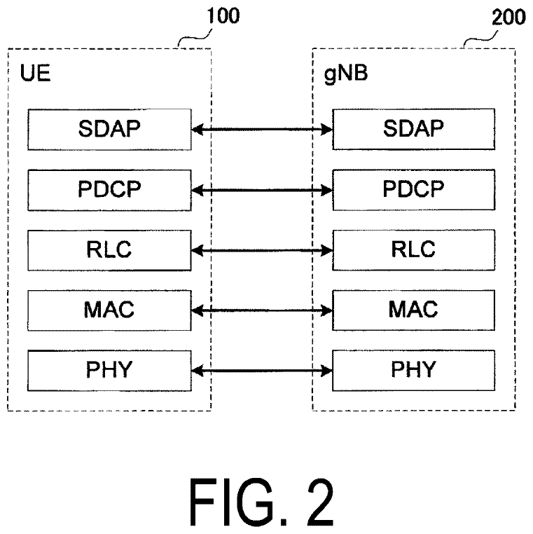

FIG. 2 is a diagram illustrating a configuration of a protocol stack of a radio interface of a user plane handling data.

The user plane radio interface protocol includes a physical (PHY) layer, a medium access control (MAC) layer, a radio link control (RLC) layer, a packet data convergence protocol (PDCP) layer, and a service data adaptation protocol (SDAP) layer.

The PHY layer performs encoding/decoding, modulation/demodulation, antenna mapping/demapping, and resource mapping/demapping. Data and control information are transmitted between the PHY layer of the UE 100 and the PHY layer of the gNB 200 via a physical channel. The PHY layer of the UE 100 receives downlink control information (DCI) transmitted from the gNB 200 over a physical downlink control channel (PDCCH). Specifically, the UE 100 performs blind decoding of PDCCH using a radio network temporary identifier (RNTI) and acquires successfully decoded DCI as DCI addressed to the UE. The DCI transmitted from the gNB 200 is added with a cyclic redundancy code (CRC) bit scrambled by the RNTI.

The gNB 200 transmits a synchronization signal block (SSB: Synchronization Signal/PBCH block). For example, the SSB includes four consecutive Orthogonal Frequency Division Multiplex (OFDM) symbols, and a primary synchronization signal (PSS), a secondary synchronization signal (SSS), a physical broadcast channel (PBCH)/master information block (MIB), and a demodulation reference signal (DMRS) of the PBCH are disposed. A bandwidth of the SSB is, for example, a bandwidth of 240 consecutive subcarriers, that is, 20RB.

The MAC layer performs data priority control, retransmission processing using hybrid automatic repeat reQuest (HARQ), random access procedure, and the like.

Data and control information are transmitted between the MAC layer of the UE 100 and the MAC layer of the gNB 200 via a transport channel. The MAC layer of the gNB 200 includes a scheduler. The scheduler decides transport formats (transport block sizes, Modulation and Coding Schemes (MCSs)) in the uplink and the downlink and resource blocks to be allocated to the UE 100.

The RLC layer transmits data to the RLC layer on the receiving side using functions of the MAC layer and the PHY layer. Data and control information are transmitted between the RLC layer of the UE 100 and the RLC layer of the gNB 200 via a logical channel.

The PDCP layer performs header compression/decompression, encryption/decryption, and the like.

The SDAP layer performs mapping between IP flows, which are units for quality of service (QOS) control in the core network, and radio bearers, which are units for QoS control in an access stratum (AS). Note that, when the RAN is connected to the EPC, the SDAP need not be provided.

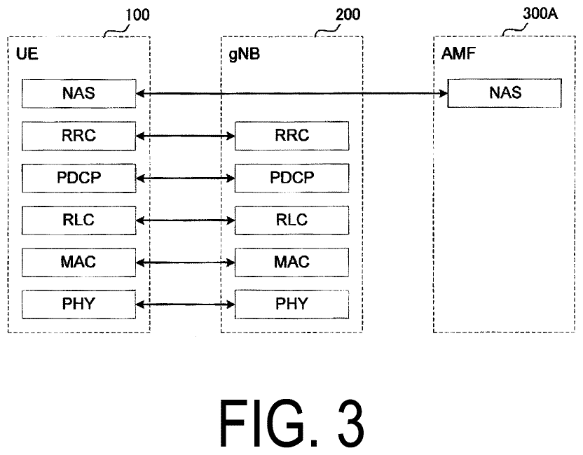

FIG. 3 is a diagram illustrating a configuration of a protocol stack of a radio interface of a control plane handling signaling (a control signal).

The protocol stack of the radio interface of the control plane includes a Radio Resource Control (RRC) layer and a Non-Access Stratum (NAS) layer instead of the SDAP layer illustrated in FIG. 2.

RRC signaling for various configurations is transmitted between the RRC layer of the UE 100 and the RRC layer of the gNB 200. The RRC layer controls a logical channel, a transport channel, and a physical channel according to establishment, re-establishment, and release of a radio bearer. When a connection (RRC connection) between the RRC of the UE 100 and the RRC of the gNB 200 is present, the UE 100 is in an RRC connected state. When no connection (RRC connection) between the RRC of the UE 100 and the RRC of the gNB 200 is present, the UE 100 is in an RRC idle state. When the connection between the RRC of the UE 100 and the RRC of the gNB 200 is suspended, the UE 100 is in an RRC inactive state.

The NAS layer, which is located above the RRC layer, performs session management, mobility management, and the like. NAS signaling is transmitted between the NAS layer of the UE 100 and the NAS layer of an AMF 300A. The UE 100 includes an application layer other than the protocol of the radio interface. A layer lower than the NAS layer is referred to as an AS layer.

### (1.2) Example of Application Scenario of Relay Apparatus

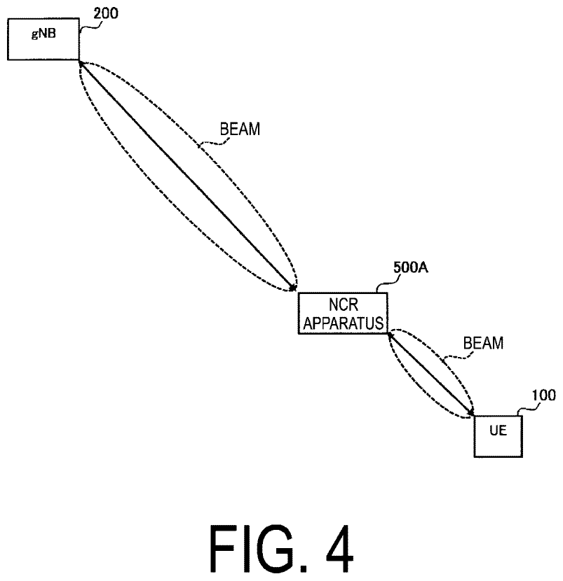

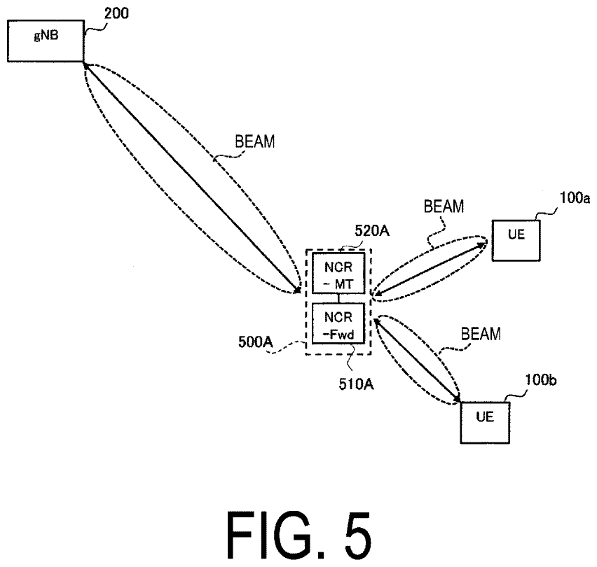

FIGS. 4 and 5 are diagrams showing an example of an application scenario of an NCR apparatus according to an embodiment.

The 5G/NR is capable of wide-band transmission via a high frequency band compared to the 4G/LTE. Since radio signals in the high frequency band such as a millimeter wave band or a terahertz wave band have high rectilinearity, a problem is reduction of coverage of the gNB 200. In FIG. 4, the UE 100 may be located outside a coverage area of the gNB 200, for example, outside an area where the UE 100 can receive radio signals directly from the gNB 200. The UE 100 may not communicate with the gNB 200 within a line of sight because of obstacles existing between the gNB 200 and the UE 100.

As illustrated in FIG. 4, a repeater apparatus (500A) that is a type of relay apparatus that relays radio signals between the gNB 200 and the UE 100, which is the NCR apparatus 500A that can be controlled from a network, is introduced into the mobile communication system 1. Such a repeater apparatus may be called a smart repeater apparatus.

For example, the NCR apparatus 500A amplifies a radio signal (radio wave) received from the gNB 200 and transmits the radio signal through directional transmission. To be specific, the NCR apparatus 500A receives a radio signal transmitted by the gNB 200 through beamforming. The NCR apparatus 500A amplifies the received radio signal without demodulation and modulation and transmits the amplified radio signal through the directional transmission. Here, the NCR apparatus 500A may transmit the radio signal with a fixed directivity (beam). The NCR apparatus 500A may transmit a radio signal with a variable (adaptive) directional beam. This can efficiently extend the coverage of the gNB 200.

Also, as illustrated in FIG. 5, a new UE (hereinafter referred to as “NCR-MT (Mobile termination)”) 100B, which is a type of control terminal for controlling the NCR apparatus 500A, is introduced. That is, the NCR apparatus 500A includes an NCR-Fwd (Forward) 510A, which is a type of a relay device that relays a radio signal transmitted between the gNB 200 and the UE 100, specifically, changes a propagation state of the radio signal without demodulating or modulating the radio signal, and an NCR-MT 520A that performs wireless communication with the gNB 200 to control the NCR-Fwd 510A. Thus, the NCR-MT 520A controls the NCR apparatus 500A in cooperation with the gNB 200 by establishing a wireless connection to the gNB 200 and performing wireless communication to the gNB 200. Accordingly, efficient coverage extension can be realized using the NCR apparatus 500A. The NCR-MT 520A controls the NCR apparatus 500A in accordance with control from the gNB 200. The NCR-MT 520A also has the same function as that of the UE 100.

The NCR-MT 520A may be configured separately from the NCR-Fwd 510A. For example, the NCR-MT 520A may be located near the NCR-Fwd 510A and may be electrically connected to the NCR-Fwd 510A. The NCR-MT 520A may be connected to the NCR-Fwd 510A by wire or wireless. Alternatively, the NCR-MT 520A may be configured integrally with the NCR-Fwd 510A. The NCR-MT 520A and the NCR-Fwd 510A may be fixedly installed at a coverage edge (cell edge) of the gNB 200, or on a wall surface or window of any building, for example. The NCR-MT 520A and the NCR-Fwd 510A may be installed, for example, in a vehicle or the like and may be mobile. One NCR-MT 520A may control the plurality of NCR-Fwds 510A.

The configuration is not limited to a configuration in which the NCR-MT 520A directly controls one or more NCR-Fwds 510A, and may be configuration in which the NCR-MT 520A indirectly controls one or more NCR-Fwds 510A. For example, the NCR-MT 520A may control one or more NCR-Fwds 510A via an upper layer (for example, an application layer).

In the example illustrated in FIG. 5, the NCR apparatus 500A (NCR-Fwd 510A) dynamically or quasi-statically changes a beam to be transmitted or received. For example, the NCR-Fwd 510A forms a beam toward each of a UE 100a and a UE 100b. The NCR-Fwd 510A may also form a beam toward the gNB 200. For example, in a communication resource between the gNB 200 and the UE 100a, the NCR-Fwd 510A transmits a radio signal received from the gNB 200 toward the UE 100a through beamforming and/or transmits a radio signal received from the UE 100a toward the gNB 200 through beamforming. In a communication resource between the gNB 200 and the UE 100b, the NCR-Fwd 510A transmits the radio signal received from the gNB 200 toward the UE 100b through beamforming and/or transmits the radio signal received from the UE 100b toward the gNB 200 through beamforming. Instead of or in addition to the beamforming, the NCR-Fwd 510A may perform null forming (so-called null steering) toward the UE 100 which is not a communication partner (not illustrated) and/or a neighboring gNB 200 (not illustrated) to curb interference.

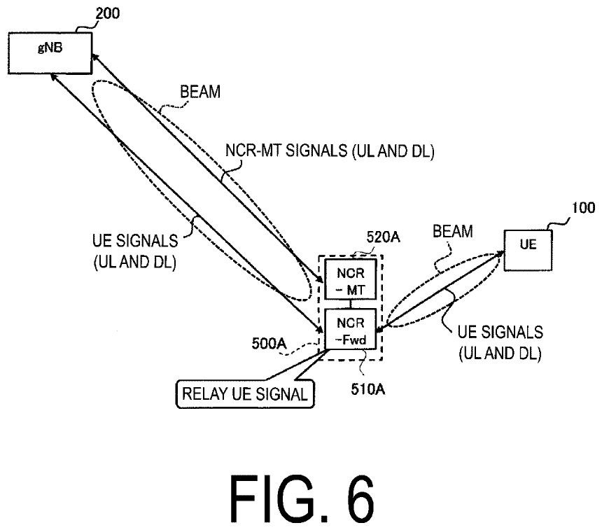

FIG. 6 is a diagram illustrating an example of a control method for the NCR apparatus 500A according to the embodiment. As illustrated in FIG. 6, the NCR-Fwd 510A relays radio signals (also referred to as “UE signals”) between the gNB 200 and the UE 100. The UE signal includes an uplink signal transmitted from the UE 100 to the gNB 200 (referred to as “UE-UL signal”) and a downlink signal transmitted from the gNB 200 to the UE 100 (referred to as “UE-DL signal”). The NCR-Fwd 510A relays the UE-UL signal from the UE 100 to the gNB 200 and relays the UE-DL signal from the gNB 200 to the UE 100. The radio link between the NCR-Fwd 510A and the UE 100 is also referred to as an “access link”. The radio link between the NCR-Fwd 510A and the gNB 200 is also referred to as a “backhaul link”.

The NCR-MT 520A transmits and receives a radio signal (herein referred to as an “NCR-MT signal”) to and from the gNB 200. The NCR-MT signal includes an uplink signal transmitted from the NCR-MT 520A to the gNB 200 (referred to as an “NCR-MT-UL signal”), and a downlink signal transmitted from the gNB 200 to the NCR-MT 520A (referred to as an “NCR-MT-DL signal”). The NCR-MT-DL signal includes signaling for controlling the NCR apparatus 500A (for example, an NCR control signal). A wireless link between the NCR-MT 520A and the gNB 200 is also referred to as a “control link.”

The gNB 200 directs a beam to the NCR-MT 520A based on the NCR-MT-UL signal from the NCR-MT 520A. Since the NCR apparatus 500A and the NCR-MT 520A are co-located, the beam is also eventually directed to the NCR-Fwd 510A when the backhaul link and the control link have the same frequency and the gNB 200 directs a beam to the NCR-MT 520A. The gNB 200 transmits the NCR-MT-DL signal and the UE-DL signal using the beam. The NCR-MT 520A receives the NCR-MT-DL signal. When the NCR-Fwd 510A and the NCR-MT 520A are at least partially integrated, a function (for example, antennas) for transmitting or receiving, or relaying UE signals and/or NCR-MT signals may be integrated in the NCR-Fwd 510A and the NCR-MT 520A. The beam includes a transmission beam and/or a reception beam. The beam is a general term for transmission and/or reception under control for maximizing power of a transmission wave and/or a reception wave in a specific direction by adjusting/adapting an antenna weight or the like.

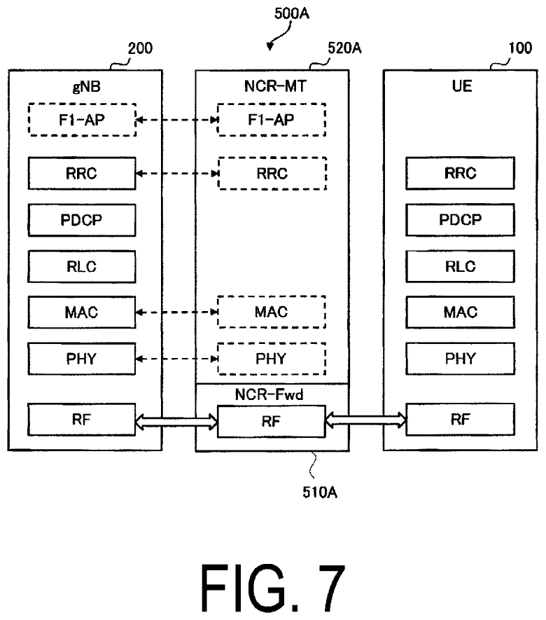

FIG. 7 is a diagram illustrating an example of a configuration of a protocol stack in the mobile communication system 1 having the NCR apparatus 500A according to an embodiment. The NCR-Fwd 510A relays a radio signal transmitted and received between the gNB 200 and the UE 100. The NCR-Fwd 510A has a Radio Frequency (RF) function of amplifying and relaying a received radio signal, and performs directional transmission through beamforming (for example, analog beamforming).

The NCR-MT 520A includes at least one layer (entity) selected from the group consisting of PHY, MAC, RRC, and application protocol (F1-AP). The F1-AP is a type of a fronthaul interface. The NCR-MT 520A exchanges signaling with the gNB 200 using at least one of PHY, MAC, RRC, and F1-AP. When the NCR-MT 520A is a type or part of a base station, the NCR-MT 520A may exchange signaling with the gNB 200 using an Xn AP (Xn-AP), which is an interface between base stations. The NCR-MT 520A may also include a NAS layer (entity). The NAS layer allows the NCR-MT 520A to exchange signaling with the AMF 300A. The NAS layer may constitute an upper layer for the NCR-MT 520A.

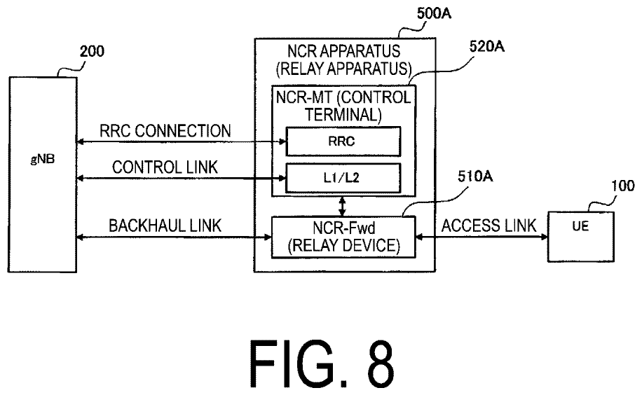

FIG. 8 is a diagram illustrating a specific example of a configuration of the mobile communication system 1 including the NCR apparatus 500A according to the embodiment.

A backhaul link is established between the gNB 200 and the NCR-Fwd 510A. An access link is established between the UE 100 and the NCR-Fwd 510A. The NCR-Fwd 510A relays a radio signal transmitted between the gNB 200 and the UE 100 via the backhaul link and the access link. The NCR-Fwd 510A changes a propagation state of the radio signal without demodulating or modulating the radio signal.

Further, a control link is established between the gNB 200 and layer 1 and/or layer 2 (L1/L2) of the NCR-MT 520A. The L1/L2 of the NCR-MT 520A transmits and receives L1/L2 signaling to and from the gNB 200 via the control link. An RRC connection is established between the gNB 200 and the RRC of the NCR-MT 520A. The RRC of the NCR-MT 520A transmits and receives an RRC message to and from the gNB 200 via the RRC connection. The NCR-MT 520A receives downlink signaling (also referred to as an “NCR control signal” or simply “control signal”) from the gNB 200 via the RRC connection and/or the control link.

The gNB 200 (transmitter 210) transmits the NCR control signal to the NCR-MT 520A. The NCR control signal may be an RRC message, which is a control signal of the RRC layer (that is, layer 3). The NCR control signal may be a MAC control element (CE), which is a control signal of the MAC layer (that is, layer 2). The NCR control signal may be downlink control information (DCI), which is a control signal of the PHY layer (that is, layer 1). The NCR control signal may be UE-specific signaling. The NCR control signal may be broadcast signaling. The NCR control signal may be a fronthaul message (for example, F1-AP message). When the NCR-MT 520A is a type or part of a base station, the NCR-MT 520A may communicate with the gNB 200 via an AP of Xn (Xn-AP), which is an inter-base station interface.

Hereinafter, the NCR control signal transmitted in the RRC message (and/or MAC CE) and used for static or semi-static control of the NCR-Fwd 510A is also referred to as “NCR configuration information” or simply “configuration information”. Here, the RRC message may be an RRC Reconfiguration message. The NCR configuration information includes, for example, information for configuring ON/OFF of the NCR-Fwd 510A. The NCR configuration information may include, for example, information for semi-static beam configuration of the NCR-Fwd 510A.

Meanwhile, the NCR control signal that is transmitted in the L1/L2 signaling, that is, the DCI (and/or MAC CE) and is used for dynamic control of the NCR-Fwd 510A is also referred to as “NCR control information” or simply “control information”. The NCR control information may be referred to as side control information (SCI). CRC bits of the PDCCH carrying the NCR control information are scrambled by a newly introduced dedicated RNTI. The dedicated RNTI is also referred to as “NCR-RNTI”. The NCR control information may include, for example, information for dynamic beam control of the NCR-Fwd 510A. The NCR configuration information may include information for instructing dynamic On/Off of the NCR-Fwd 510A.

For example, when the NCR-MT 520A is in an RRC connected state, the NCR apparatus 500A can turn on or off the NCR-Fwd 510A in accordance with the NCR control information (SCI) received from the gNB 200. On the other hand, after the NCR-MT 520A transitions to an RRC inactive state, the NCR apparatus 500A can turn on or off the NCR-Fwd 510A in accordance with the latest (last) configuration information received from the gNB 200.

Further, the NCR control signal (NCR configuration information by RRC and/or NCR control information by L1/L2 signaling) held by the NCR apparatus 500A (NCR-MT 520A) may be referred to as an NCR-Fwd context.

Also, when a radio link failure (RLF) with the gNB 200 is detected by the NCR-MT 520A, the NCR-MT 520A executes cell selection and triggers RRC connection re-establishment (also referred to as “RRC re-establishment”). Here, when the NCR-MT 520A enters the RRC idle state because a suitable cell cannot be found in the cell selection, the NCR apparatus 500A turns off the NCR-Fwd 510A. The NCR-Fwd 510A is off during an RRC connection re-establishment procedure.

The NCR control signal may include frequency information for designating a center frequency of a radio signal (for example, a component carrier) that is a relay target of the NCR-Fwd 510A. When the NCR control signal received from the gNB 200 includes the frequency information, the NCR-MT 520A (controller 523) controls the NCR-Fwd 510A so that the NCR-Fwd 510A relays a radio signal whose center frequency is indicated by the frequency information as a target (step S2A). The NCR control signal may include a plurality of pieces of frequency information for designating center frequencies different from each other. Since the NCR control signal includes the frequency information, the gNB 200 can designate the center frequency of the radio signal that is a relay target of the NCR-Fwd 510A via the NCR-MT 520A.

The NCR control signal may include mode information for designating an operation mode of the NCR-Fwd 510A. The mode information may be associated with the frequency information (center frequency). The operation mode may be any one of a mode in which the NCR-Fwd 510A performs non-directional transmission and/or reception, a mode in which the NCR-Fwd 510A performs fixed-directional transmission and/or reception, a mode in which the NCR-Fwd 510A performs transmission and/or reception with a variable directional beam, and a mode in which the NCR-Fwd 510A performs Multiple Input Multiple Output (MIMO) relay transmission. The operation mode may be either a beamforming mode (that is, a mode in which improvement of a desired wave is emphasized) and a null steering mode (that is, a mode in which curbing of an interference wave is emphasized). When the NCR control signal received from the gNB 200 includes the mode information, the NCR-MT 520A (controller 523) controls the NCR-Fwd 510A so that the NCR-Fwd 510A operates in the operation mode indicated by the mode information (step S2A). Since the NCR control signal includes the mode information, the gNB 200 can designate the operation mode of the NCR-Fwd 510A via the NCR-MT 520A.

Here, a mode in which the NCR apparatus 500A performs omnidirectional transmission and/or reception is a mode in which the NCR-Fwd 510A performs relaying in all directions, and may be referred to as an omni mode. The mode in which the NCR-Fwd 510A performs fixed-directional transmission and/or reception may be a directivity mode realized by one directional antenna. The mode may be a beamforming mode realized by applying fixed phase and amplitude control (antenna weight control) to a plurality of antennas. Any of these modes may be designated (set) from the gNB 200 to the NCR-MT 520A. The mode in which the NCR-Fwd 510A performs transmission and/or reception with a variable directional beam may be a mode for performing analog beamforming. The mode may be a mode in which digital beamforming is performed. The mode may be a mode in which hybrid beamforming is performed. The mode may be a mode for forming an adaptive beam specific to the UE 100. Any of these modes may be designated (set) from the gNB 200 to the NCR-MT 520A. In the operation mode in which beamforming is performed, beam information to be described below may be provided from the gNB 200 to the NCR-MT 520A. The mode in which the NCR apparatus 500A performs MIMO relay transmission may be a mode for performing single-user (SU) spatial multiplexing. The mode may be a mode for performing Multi-User (MU) spatial multiplexing. The mode may be a mode for performing transmission diversity. Any of these modes may be designated (set) from the gNB 200 to the NCR-MT 520A. The operation mode may include a mode in which relay transmission by the NCR-Fwd 510A is turned on (activated) and a mode in which the relay transmission by the NCR-Fwd 510A is turned off (deactivated). Any of these modes may be designated (set) from the gNB 200 to the NCR-MT 520A in the NCR control signal.

The NCR control signal may include beam information for designating a transmission direction, a transmission weight, or a beam pattern when the NCR-Fwd 510A performs directional transmission. The beam information may be associated with the frequency information (center frequency). The beam information may include a precoding matrix indicator (PMI). The beam information may include beamforming angle information. When the NCR control signal received from the gNB 200 includes beam information, the NCR-MT 520A (controller 523) controls the NCR-Fwd 510A to form a transmission directivity (beam) indicated by the beam information. When the NCR control signal includes the beam information, the gNB 200 can control the transmission directivity of the NCR apparatus 500A via the NCR-MT 520A.

The NCR control signal may include transmission power information for designating a degree to which the NCR-Fwd 510A amplifies the radio signal (amplification gain) or the transmission power. The transmission power information may be information indicating a difference value (that is, a relative value) between a current amplification gain or transmission power and a target amplification gain or transmission power. When the NCR control signal received from the gNB 200 includes transmission power information, the NCR-MT 520A (controller 523) controls the NCR-Fwd 510A to change to the amplification gain or transmission power indicated by the transmission power information. The transmission power information may be associated with frequency information (center frequency). The transmission power information may be information for designating any one of an amplification gain, a beamforming gain, and an antenna gain of the NCR-Fwd 510A. The transmission power information may be information for designating transmission power of the NCR-Fwd 510A.

When one NCR-MT 520A controls the plurality of NCR-Fwds 510A, the gNB 200 (transmitter 210) may transmit an NCR control signal to the NCR-MT 520A for each NCR-Fwd 510A. In this case, the NCR control signal may include an identifier of the corresponding NCR-Fwd 510A (NCR identifier). The NCR-MT 520A (controller 523) controlling the plurality of NCR-Fwds 510A determines the NCR-Fwd 510A to which the NCR control signal is applied, based on the NCR identifier included in the NCR control signal received from the gNB 200. The NCR identifier may be transmitted together with the NCR control signal from the NCR-MT 520A to the gNB 200 even when the NCR-MT 520A controls only one NCR-Fwd 510A.

Thus, the NCR-MT 520A (controller 523) controls the NCR-Fwd 510A based on the NCR control signal from the gNB 200. This enables the gNB 200 to control the NCR-Fwd 510A via the NCR-MT 520A.

### (1.3) Example of Configuration of Each Apparatus

An example of a configuration of each apparatus in the mobile communication system 1 according to the embodiment will be described.

### (1.3.1) Example of Configuration of Relay Apparatus

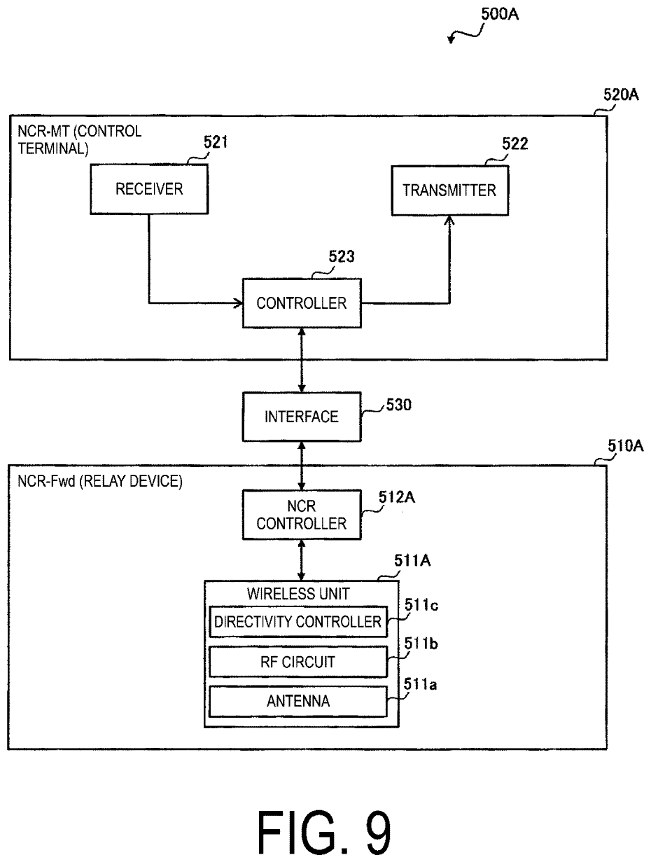

FIG. 9 is a diagram illustrating an example of a configuration of the NCR apparatus 500A (relay apparatus) according to the embodiment. The NCR apparatus 500A includes an NCR-Fwd 510A, an NCR-MT 520A, and an interface 530.

The NCR-Fwd 510A includes a wireless unit 511A and an NCR controller 512A. The wireless unit 511A includes an antenna 511a including a plurality of antennas (a plurality of antenna elements), an RF circuit 511b including an amplifier, and a directivity controller 511c that controls directivity of the antenna 511a. The RF circuit 511b amplifies and relays (transmits) radio signals transmitted and received by the antenna 511a. The RF circuit 511b may convert a radio signal, which is an analog signal, into a digital signal, and reconvert the digital signal into an analog signal after digital signal processing. The directivity controller 511c may perform analog beamforming through analog signal processing. The directivity controller 511c may perform digital beamforming through digital signal processing. The directivity controller 511c may perform analog and digital hybrid beamforming. The NCR controller 512A controls the wireless unit 511A in response to a control signal from the NCR-MT 520A. The NCR controller 512A may include at least one processor.

The NCR-MT 520A includes a receiver 521, a transmitter 522, and a controller 523. The receiver 521 performs various types of reception under control of the controller 523. The receiver 521 includes an antenna and a reception device. The reception device converts a radio signal received by the antenna (radio signal) into a baseband signal (a reception signal) and outputs the reception signal to the controller 523. The transmitter 522 performs various types of transmission under control of the controller 523. The transmitter 522 includes an antenna and a transmission device. The transmission device converts a baseband signal (a transmission signal) output by the controller 523 into a radio signal and transmits the radio signal from the antenna. The controller 523 performs various types of controls in the NCR-MT 520A. The operation of the NCR-MT 520A (and the NCR apparatus 500A) described above and to be described below may be an operation controlled by the controller 523. The controller 523 includes at least one processor and at least one memory. The memory stores a program to be executed by the processor and information to be used for processing by the processor. The processor may include a baseband processor and a Central Processing Unit (CPU). The baseband processor performs modulation and demodulation, coding and decoding, and the like of a baseband signal. The CPU executes the program stored in the memory to thereby perform various types of processing. The controller 523 executes a function of at least one layer selected from the group consisting of the PHY, the MAC, the RRC, and the F1-AP.

The interface 530 electrically or logically connects the NCR-Fwd 510A and the NCR-MT 520A. The controller 523 of the NCR-MT 520A controls the NCR-Fwd 510A via the interface 530. The interface 530 may be a logical entity of an upper layer (for example, an application layer).

In an embodiment, the receiver 521 of the NCR-MT 520A receives signaling (NCR control signal) used to control the NCR apparatus 500A from the gNB 200 through wireless communication. The controller 523 of the NCR-MT 520A controls the NCR apparatus 500A based on the signaling. This enables the gNB 200 to control the NCR-Fwd 510A via the NCR-MT 520A.

### (1.3.2) Example of Configuration of User Equipment

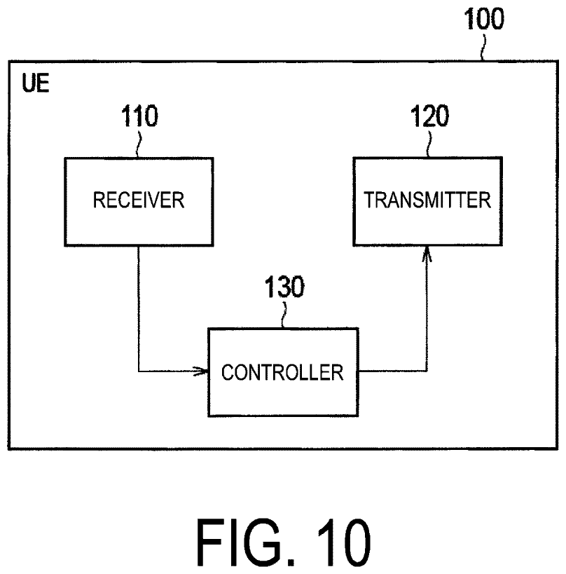

FIG. 10 is a diagram illustrating a configuration of the UE 100 (user equipment) according to an embodiment. The UE 100 includes a receiver 110, a transmitter 120, and a controller 130. The receiver 110 and the transmitter 120 constitute a wireless communicator that performs wireless communication with the gNB 200.

The receiver 110 performs various receptions under the control of the controller 130. The receiver 110 includes an antenna and a reception device. The reception device converts a radio signal received through the antenna into a baseband signal (a reception signal) and outputs the resulting signal to the controller 130.

The transmitter 120 performs various transmissions under the control of the controller 130. The transmitter 120 includes an antenna and a transmission device. The transmission device converts a baseband signal (a transmission signal) output by the controller 130 into a radio signal and transmits the resulting signal through the antenna.

The controller 130 performs various controls and processes in the UE 100. Such processing includes processing of respective layers to be described later. The operations of the UE 100 described above and to be described below may also be an operation under the control of the controller 130. The controller 130 includes at least one processor and at least one memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory to thereby perform various types of processing.

### (1.3.3) Example of Configuration of Base Station

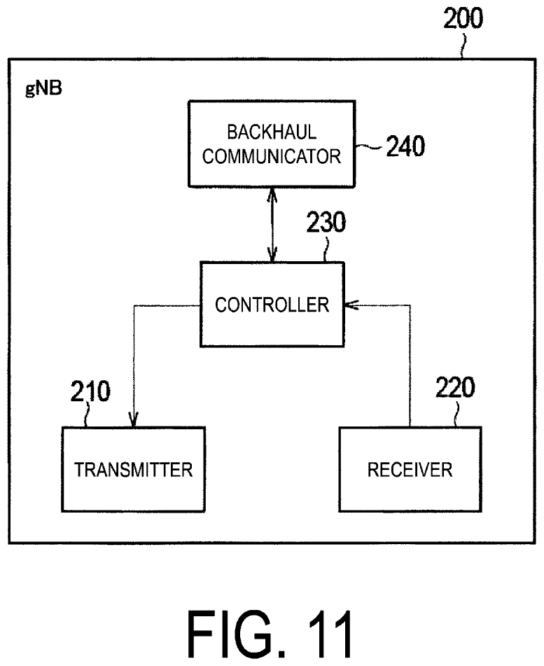

FIG. 11 is a diagram illustrating an example of a configuration of the gNB 200 (base station) according to an embodiment. The gNB 200 includes a transmitter 210, a receiver 220, a controller 230, and a backhaul communicator 240.

The transmitter 210 performs various transmissions under the control of the controller 230. The transmitter 210 includes an antenna and a transmission device. The transmission device converts a baseband signal (a transmission signal) output by the controller 230 into a radio signal and transmits the resulting signal through the antenna. The receiver 220 performs various types of reception under control of the controller 230. The receiver 220 includes an antenna and a reception device. The reception device converts a radio signal received through the antenna into a baseband signal (a reception signal) and outputs the resulting signal to the controller 230. The transmitter 210 and the receiver 220 may be capable of beamforming using a plurality of antennas.

The controller 230 performs various types of control for the gNB 200. The operation of the gNB 200 described above and to be described below may be an operation under the control of the controller 230. The controller 230 includes at least one processor and at least one memory. The memory stores a program to be executed by the processor and information to be used for processing in the processor. The processor may include a baseband processor and a CPU. The baseband processor performs modulation and demodulation, coding and decoding, and the like of a baseband signal. The CPU executes the program stored in the memory to thereby perform various types of processing.

The backhaul communicator 240 is connected to a neighboring base station via the inter-base station interface. The backhaul communicator 240 is connected to the AMF/UPF 300 via the interface between a base station and the core network. The gNB may include a Central Unit (CU) and a Distributed Unit (DU) (that is, functions are divided), and both units may be connected via an F1 interface.

In the embodiment, the transmitter 210 of the gNB 200 transmits signaling (NCR control signal) used for control of the NCR-Fwd 510A to the NCR-MT 520A through wireless communication. This enables the gNB 200 to control the NCR apparatus 500A via the NCR-MT 520A.

### (1.4) Operation According to First Embodiment

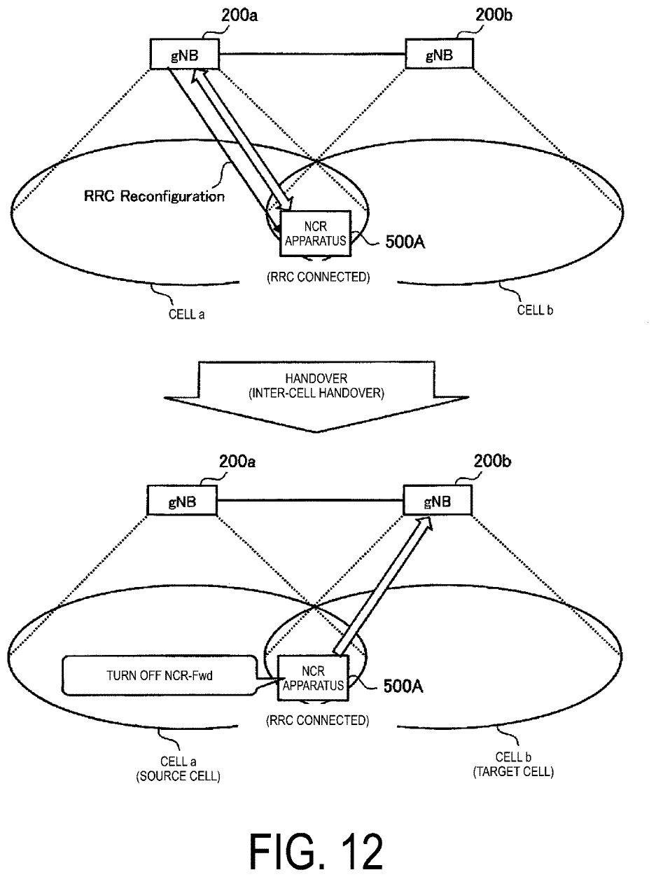

An operation according to a first embodiment will be described. FIG. 12 is a diagram illustrating an example of an operation scenario according to the first embodiment. In the illustrated example, the NCR apparatus 500A is in a state in which an RRC connection is established with the cell a of the gNB 200a (RRC connected state). That is, the cell a is a serving cell of the NCR apparatus 500A. Also, the NCR apparatus 500A is geographically located in the overlap region of the cell a of the gNB 200a and the cell b of the gNB 200b. The cell a and the cell b may be managed by the same gNB 200.

The NCR apparatus 500A (NCR-MT 520A) receives the RRC Reconfiguration message from the cell a (gNB 200a). The RRC Reconfiguration message may be used for handover of the NCR-MT 520A in the RRC connected state. Here, two types of handover are present: intra-cell handover and inter-cell handover. The intra-cell handover is a handover of the NCR-MT 520A to the same cell (the cell a in the illustrated example) for the purpose of security key change or the like. On the other hand, the inter-cell handover is a general handover in which the serving cell of the NCR-MT 520A is changed.

The NCR-MT 520A supports, for example, a data radio bearer (DRB) for transmission of traffic of operation administration and maintenance (OAM). Therefore, it may be necessary to perform an intra-cell handover of the NCR-MT 520A, for example, for a security key change. In the case of the intra-cell handover, since the NCR-MT 520A connects to the same cell, it is desirable for the operation of the NCR-Fwd 510A to continue in accordance with the NCR control signal last received before the intra-cell handover (also referred to as a “latest NCR control signal”), in particular the latest NCR configuration information. On the other hand, in the case of the inter-cell handover, since the NCR-MT 520A connects to a different cell (the cell b in the illustrated example), it is desirable to turn off the NCR-Fwd 510A.

The communication method according to the first embodiment is a method that is used in the NCR apparatus 500A including the NCR-Fwd 510A that performs a relay operation of relaying radio signal transmitted between the network 5 and the UE 100, and an NCR-MT 520A that receives an NCR control signal used for control of the NCR-Fwd 510A from the network 5. The NCR-MT 520A in the RRC connected state receives the RRC Reconfiguration message from the network 5. When the NCR apparatus 500A (NCR-MT 520A) changes the serving cell of the NCR-MT 520A based on the RRC Reconfiguration message, the NCR apparatus 500A turns off the NCR-Fwd 510A that performs a relay operation on the serving cell. On the other hand, when the serving cell is maintained based on the RRC Reconfiguration message, the NCR apparatus 500A (NCR-MT 520A) continues the relay operation for the serving cell.

Thus, in the first embodiment, when the NCR apparatus 500A (NCR-MT 520A) receives the RRC Reconfiguration message, the NCR apparatus 500A continues to control the operation of the NCR-Fwd 510A if the connection to the same cell is maintained (that is, in the case of the intra-cell handover), and the NCR apparatus 500A stops (forcibly turns off) the NCR-Fwd 510A if the connection to a different cell is to be maintained (that is, in the case of the inter-cell handover).

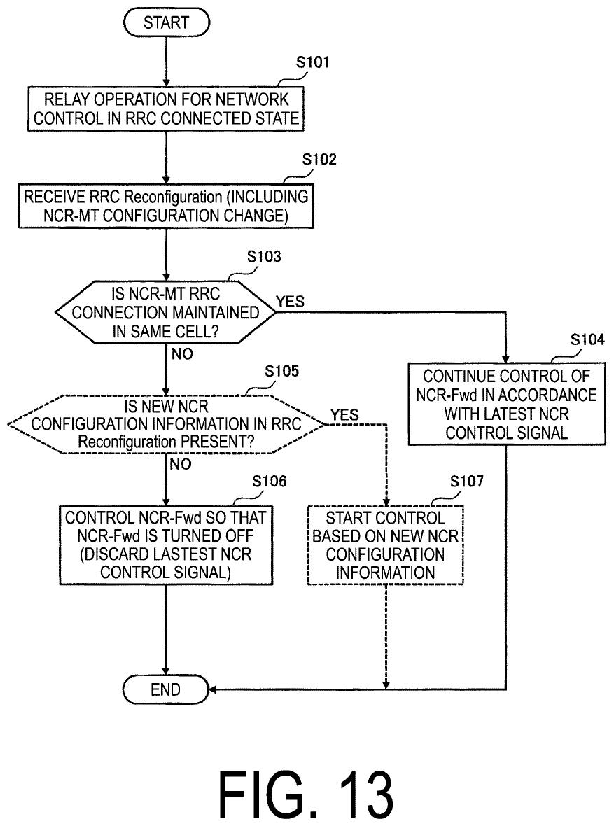

FIG. 13 is a diagram illustrating an example of an operation according to the first embodiment.

In step S101, the NCR-MT 520A in the RRC connected state receives an NCR control signal from the gNB 200 and controls the NCR-Fwd 510A (relay operation) in accordance with the received NCR control signal.

In step S102, the NCR-MT 520A receives the RRC Reconfiguration message from the gNB 200. The RRC Reconfiguration message includes a configuration change (which may be with sync) for the NCR-MT 520A. “With sync” means that information elements used for handover are included. Specifically, when the RRC Reconfiguration message includes a reconfiguration With Sync IE, this is referred to as RRC Reconfiguration with sync, which is a reconfiguration accompanied by synchronization with the target cell configured by RRC Reconfiguration with sync, and corresponds to a handover command.

In step S103, the NCR-MT 520A determines whether the RRC connection of the NCR-MT 520A is maintained in the same cell according to the reconfiguration. When it is determined that the RRC connection of the NCR-MT 520A is maintained in the same cell (step S103: YES), the NCR-MT 520A continues to control the NCR-Fwd 510A in accordance with the latest NCR control signal that the NCR-MT 520A holds in step S104. The operation of step S104 may be performed when the RRC Reconfiguration message received in step S102 does not include reconfiguration (configuration information) of the NCR-Fwd 510A. In other words, since no new configuration of the NCR-Fwd 510A is present, the NCR-MT 520A continues to use a previous configuration.

On the other hand, when it is determined that the RRC connection of the NCR-MT 520A moves to a different cell (that is, inter-cell handover) (step S103: NO), the NCR-MT 520A may perform the determination in step S105. However, the determination in step S105 may be omitted, and when the determination in step S103 is NO, the process may proceed to step S106.

In step S105, the NCR-MT 520A determines whether the RRC Reconfiguration message received in step S102 includes the new configuration of the NCR-Fwd 510A. When the new configuration of the NCR-Fwd 510A is not included (step S105: NO), the NCR-MT 520A turns off the NCR-Fwd 510A in step S106. In this case, the NCR-MT 520A may discard the latest NCR control signal that the NCR-MT 520A holds. The operation of step S106 may be performed at a timing when the NCR-MT 520A receives the RRC Reconfiguration message and confirms that access to a different cell is set (that is, an inter-cell handover command). Alternatively, the operation of step S106 may be performed at a timing when the access to a different cell is started (that is, a timing when a random access channel (RACH) procedure is started). Alternatively, the operation of step S106 may be performed at a timing when the access to a different cell is successful (that is, a timing when the RACH procedure is completed) or a timing when an RRC Reconfiguration Complete message is transmitted to the target cell.

On the other hand, when the RRC Reconfiguration message received in step S102 includes a new configuration of the NCR-Fwd 510A (step S105: YES), the RRC Reconfiguration message includes a control configuration of the NCR-Fwd 510A by the target cell (target gNB 200).

Here, when the new configuration of the NCR-Fwd 510A is a full configuration (that is, when the configurations of all the NCR-Fwds 510A are reconfigured), the NCR-MT 520A may apply the new NCR-Fwd 510A configuration (and discard the old NCR-Fwd 510A configuration) at any of the above timings and start controlling the NCR-Fwd 510A. On the other hand, when the new configuration of the NCR-Fwd 510A is a delta configuration (that is, when only some of the configurations of the NCR-Fwd 510A are reconfigured), the NCR-MT 520A may apply the new configuration of the NCR-Fwd 510A at any of the above timings and start controlling the NCR-Fwd 510A. In other words, the NCR-MT 520A uses the old configurations as a base, rewrites any new configuration IE with the new configuration, and then controls the NCR-Fwd 510A. Therefore, when the RRC Reconfiguration message includes the new configuration of the NCR-Fwd 510A, control of the NCR-Fwd 510A may be continued (not turned off).

### (1.5) First Variation of First Embodiment

A first variation of the first embodiment will be described, focusing mainly on differences from the first embodiment described above. The present variation may be implemented in combination with the first embodiment described above.

The present variation is an example using carrier aggregation (CA). The NCR-MT 520A may be configured with CA by the gNB 200. In the CA, a plurality of component carriers (CCs) corresponding to a plurality of serving cells are aggregated, and the NCR-MT 520A can simultaneously receive or transmit on a plurality of CCs (a plurality of cells). The plurality of CCs may be continuous in the frequency direction. The plurality of CCs may be discontinuous. When the CA is configured, the NCR-MT 520A has one RRC connection with the network 5 (for example, the gNB 200). One serving cell is called a primary cell (PCell). A set of serving cells can be formed by configuring a secondary cell (SCell) together with a PCell for the NCR-MT 520A. Therefore, the set of serving cells configured for the NCR-MT 520A includes one PCell and one or more SCells. Reconfiguration, addition, deletion, activation, and deactivation of the SCell can be executed by RRC. Activation and deactivation of the SCell can also be performed by a MAC CE (Control Element).

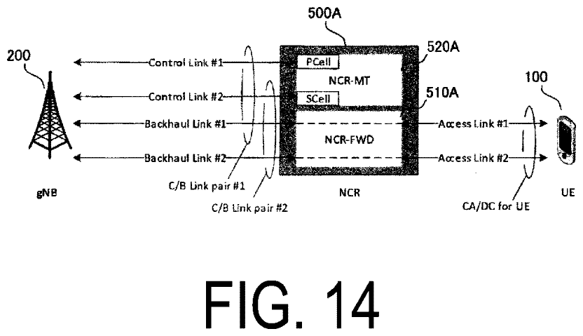

FIG. 14 is a diagram illustrating an example of an operation scenario according to a first variation of the first embodiment.

A PCell and an SCell are configured in the NCR-MT 520A. The NCR-Fwd 510A relays the PCell and the SCell. The NCR-MT 520A feeds back channel state information (CSI) for the PCell link (Backhaul Link #1) on the PCell (Control Link #1) and receives the SCI of the NCR-Fwd 510A for PCell relay on the PCell (Control Link #1). Further, the NCR-MT 520A feeds back CSI of the SCell link (Backhaul Link #2) on the SCell (Control Link #2) and receives the SCI of the NCR-Fwd 510A for SCell relay on the SCell (Control Link #2).

In the illustrated example, only one SCell is present, but a plurality of SCells may be present. Further, although an example in which one NCR-Fwd 510A relays each serving cell (PCell and at least one SCell) is illustrated, a different NCR-Fwd 510A may relay each serving cell. The different NCR-Fwds 510A may each have a different relay frequency. For each relay frequency (link) of the NCR-Fwd 510A, a corresponding SCell may be configured and activated for the NCR-MT 520A.

In the preset variation, when the NCR-MT 520A receives the RRC Reconfiguration message, the NCR-MT 520A continues to control the NCR-Fwd 510A if the SCell is maintained (and activated) and turns off the NCR-Fwd 510A that relays the SCell if the SCell is deactivated or a different SCell is configured.

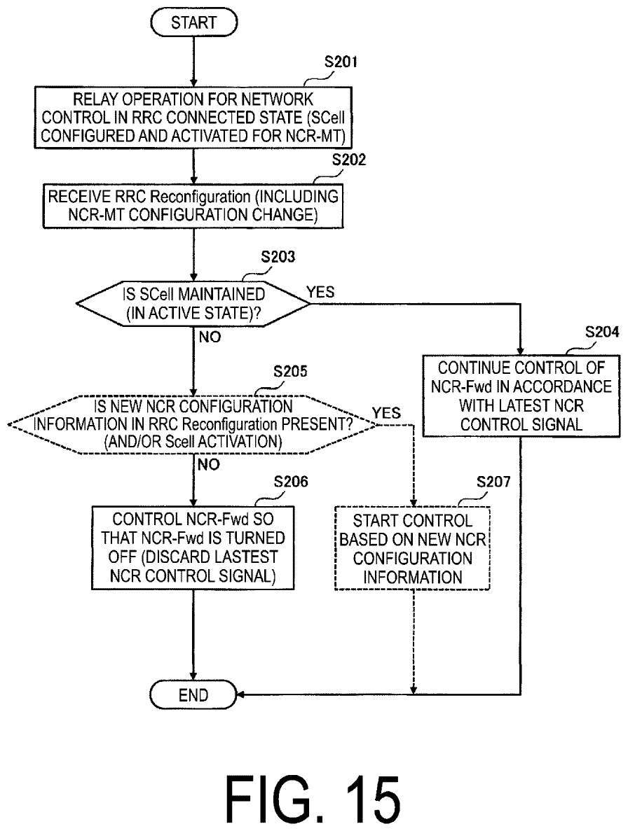

FIG. 15 is a diagram illustrating an example of an operation according to the first variation of the first embodiment. Here, operations different from the first embodiment described above are mainly described, and overlapping descriptions are omitted.

In step S201, the NCR-MT 520A in the RRC connected state controls the NCR-Fwd 510A according to the configuration (and control) from the gNB 200. Here, it is assumed that the SCell is configured and activated in the NCR-MT 520A for SCell relaying.

In step S202, the NCR-MT 520A receives the RRC Reconfiguration message from the gNB 200. The RRC Reconfiguration message includes a configuration change (which may be with sync) for the NCR-MT 520A.

In step S203, the NCR-MT 520A determines whether the reconfiguration will result in the SCell being maintained in the same cell. When it is determined that the SCell is maintained in the same cell (step S203: YES), the NCR-MT 520A continues to control the NCR-Fwd 510A in accordance with the latest NCR control signal that the NCR-MT 520A holds in step S204. The NCR-MT 520A may perform the operation of step S204 when the SCell is maintained in the same cell and an active state of the SCell is maintained. The NCR-MT 520A may turn off the NCR-Fwd 510A when the SCell is deactivated.

When it is determined that the SCell is not maintained in the same cell, that is, that the SCell is changed to a different cell (step S203: NO), the NCR-MT 520A may perform the determination of step S205. However, the determination of step S205 may be omitted, and when the result of step S203 is NO, the process may proceed to step S206.

In step S205, the NCR-MT 520A determines whether the RRC Reconfiguration message received in step S202 includes the new configuration of the NCR-Fwd 510A and whether the SCell is activated. Note that the SCell initial state in the RRC Reconfiguration message is activated or the SCell is activated by the MAC CE.

When the RRC Reconfiguration message received in step S202 does not include the new configuration of the NCR-Fwd 510A or the SCell is deactivated (step S205: NO), the NCR-MT 520A turns off the NCR-Fwd 510A in step S206. In this case, the NCR-MT 520A may discard the latest NCR control signal that the NCR-MT 520A holds. The timing of the off control is the same as in the first embodiment described above.

On the other hand, when the RRC Reconfiguration message received in step S202 includes the new configurations of the NCR-Fwd 510A and the SCell is activated (step S205: YES), the NCR-MT 520A may start controlling the NCR-Fwd 510A for the SCell based on the new configuration of the NCR-Fwd 510A in step S207. Here, when the new configuration of the NCR-Fwd 510A is a full configuration, the NCR-MT 520A may apply the new configuration of the NCR-Fwd 510A at any of the above timings and start controlling the NCR-Fwd 510A. When the new configuration of the NCR-Fwd 510A is a delta configuration, the NCR-MT 520A may apply the new configuration of the NCR-Fwd 510A at any of the above timings and start controlling the NCR-Fwd 510A. Therefore, when the RRC Reconfiguration message (and the SCell is activated) includes the new configuration of the NCR-Fwd 510A, the control of the NCR-Fwd 510A may continue (not be turned off).

### (1.6) Second Variation of First Embodiment

A second variation of the first embodiment will be described, focusing mainly on differences from the first embodiment and its variations described above. The present variation may be implemented in combination with the first embodiment and/or its variations described above.

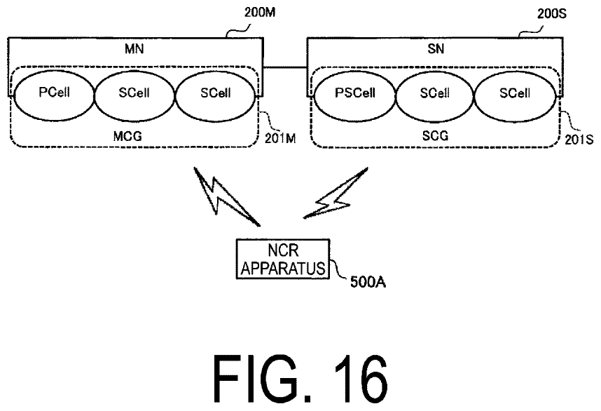

The present variation is an example that uses dual connectivity (DC). FIG. 16 is a diagram illustrating dual connectivity (DC). In the DC, the NCR-MT 520A communicates with a master cell group (MCG) 201M managed by a master node (MN) 200M and a secondary cell group (SCG) 201S managed by a secondary node (SN) 200S. The MN 200M and the SN 200S are connected to each other via a network interface (specifically, an inter-base station interface). The network interface may be an Xn interface or an X2 interface. Both the MN 200M and the SN 200S may be the gNB 200.

For example, the DC is initiated when the MN 200M transmits a predetermined message (for example, an SN Addition Request message) to the SN 200S, and the MN 200M transmits the RRC Reconfiguration message to the NCR-MT 520A. In the DC, the NCR-MT 520A in the RRC connected state is assigned radio resources by respective schedulers of the MN 200M and the SN 200S, and performs wireless communication using the radio resources of the MN 200M and the radio resources of the SN 200S.

The MN 200M may have a control plane connection with a core network. The MN 200M provides main radio resources for the NCR-MT 520A. The MN 200M manages the MCG 201M. The MCG 201M is a group of serving cells associated with the MN 200M. The MCG 201M includes a primary cell (PCell) and optionally includes one or more secondary cells (SCell). On the other hand, the SN 200S may not have a control plane connection to the core network. The SN 200S provides additional radio resources to the NCR-MT 520A. The SN 200S manages the SCG 201S. The SCG 201S includes a primary/secondary cell (PSCell) and optionally includes one or more SCells. The PCell of the MCG 201M and the PSCell of the SCG 201S are sometimes referred to as special cells (SpCells).

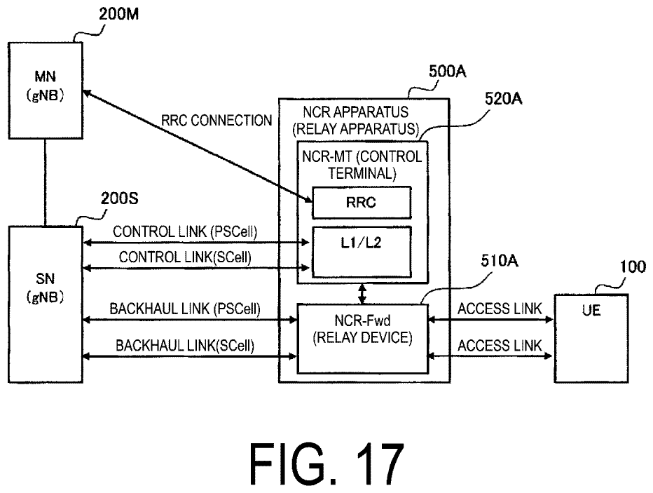

FIG. 17 is a diagram illustrating an example of an operation scenario according to the second variation of the first embodiment.

An MCG (cell group of the MN 200M) and an SCG (cell group of the SN 200S) are configured in the NCR-MT 520A. The NCR-MT 520A has an RRC connection to the MN 200M (MCG). A PSCell and an SCell are configured in the SCG. The NCR-Fwd 510A relays the PSCell and the SCell. The NCR-MT 520A performs CSI feedback of a PSCell link on the PSCell (control link) and receives the SCI of the NCR-Fwd 510A for relaying the PSCell on the PSCell (control link). Further, the NCR-MT 520A performs CSI feedback of the SCell link on the SCell (control link) and receives the SCI of the NCR-Fwd 510A for relaying the SCell on the SCell (control link).

In the illustrated example, only one SCell is present, but a plurality of SCells may be present. Further, an example in which one NCR-Fwd 510A relays each serving cell (PSCell and at least one SCell) is shown, but a configuration in which a different NCR-Fwd 510A relays each serving cell may also be used. The different NCR-Fwds 510A may each have a different relay frequency. For each relay frequency (link) of the NCR-Fwd 510A, a corresponding SCell may be configured and activated for the NCR-MT 520A.

In such a DC, an operation of changing the SCG (particularly, the PSCell) based on the RRC Reconfiguration message is called an SCG change. In the present variation, when the NCR-MT 520A receives the RRC Reconfiguration message, the NCR-MT 520A continues to control the operation of the NCR-Fwd 510A if the connection to the same cell is maintained for the PSCell, and the NCR-Fwd 510A is stopped (forcibly turned off) if the PSCell is changed to a different cell.

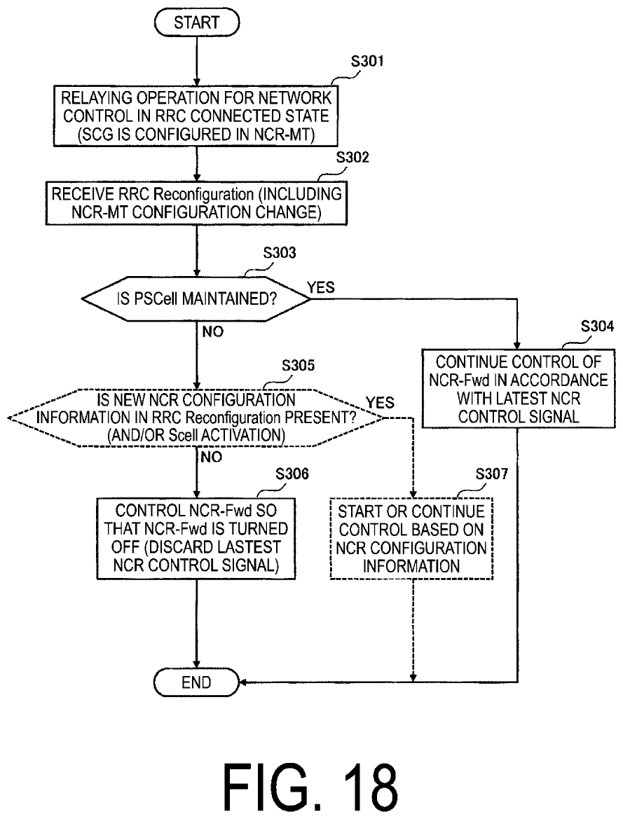

FIG. 18 is a diagram illustrating an example of an operation according to the second variation of the first embodiment. Here, operations different from those of the first embodiment and its variations described above will be mainly described, and overlapping descriptions will be omitted.

In step S301, the NCR-MT 520A in the RRC connected state controls the NCR-Fwd 510A according to configuration (and control) from the gNB 200 (the MN 200M and/or the SN 200S). Here, it is assumed that the NCR-MT 520A controls the NCR-Fwd 510A that relays the PSCell (SCG).

In step S302, the NCR-MT 520A receives the RRC Reconfiguration message from the gNB 200 (the MN 200M). The RRC Reconfiguration message includes a configuration change (which may be with sync) for the NCR-MT 520A.

In step S303, the NCR-MT 520A determines whether the PSCell of the NCR-MT 520A is maintained in the same cell as a result of the reconfiguration. When it is determined that the PSCell of the NCR-MT 520A is maintained in the same cell (step S303: YES), the NCR-MT 520A continues to control the corresponding NCR-Fwd 510A in accordance with the latest NCR control signal that the NCR-MT 520A holds.

On the other hand, when it is determined that the PSCell of the NCR-MT 520A moves to a different cell (that is, SCG change) (step S303: NO), the NCR-MT 520A may perform a determination in step S305. However, the determination in step S305 may be omitted, and when the result in step S303 is NO, the process may proceed to step S306.

When the RRC Reconfiguration message received in step S302 does not include the new configuration of the NCR-Fwd 510A (step S305: NO), the NCR-MT 520A turns off the NCR-Fwd 510A in step S306. Here, the held latest NCR control signal may be discarded. The timing of the off control is the same as in the first embodiment described above.

On the other hand, when the RRC Reconfiguration message received in step S302 includes the new configuration of the NCR-Fwd 510A (step S305: YES), the NCR-MT 520A performs the following operation in step S307. When the new configuration of the NCR-Fwd 510A is a full configuration, the new NCR-Fwd 510A configuration is applied at any of the above timings, and control of the NCR-Fwd 510A is started. When the new NCR-Fwd 510A configuration is a delta configuration, the new NCR-Fwd 510A configuration is applied at any of the above timings, and control of the NCR-Fwd 510A is started. Therefore, when the RRC Reconfiguration message includes the new NCR-Fwd 510A configuration, the NCR-Fwd 510A control may be continued (not turned off).

### (1.7) Third Variation of First Embodiment

A third variation of the first embodiment will be described, focusing mainly on differences from the first embodiment and its variations described above. The present variation may be implemented in combination with the first embodiment and/or its variations described above.

The present variation is the same as the second variation described above in that DC is used. However, the present variation is an example in which deactivation of the SCG is assumed. The SCG can be deactivated by the RRC Reconfiguration message. In a deactivated SCG, some activities for the PSCell such as measurements continue, unlike the case of deconfiguring/releasing the SCG. For example, the efficiency of the DC can be improved by temporarily deactivating the SCG for a period when the SCG is not used.

In the present variation, when SCG deactivation is performed, the NCR-MT 520A turns off the NCR-Fwd 510A corresponding to the serving cell (PSCell and/or SCell) belonging to the SCG.

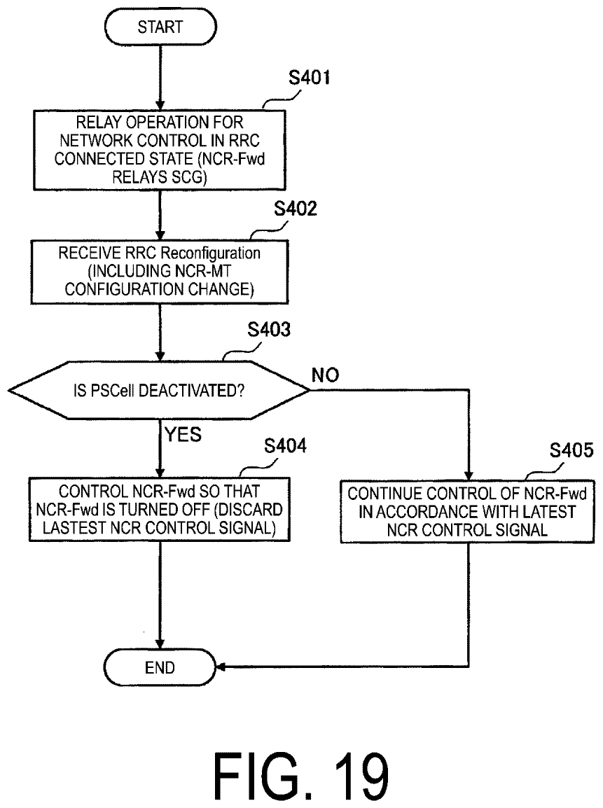

FIG. 19 is a diagram illustrating an example of an operation according to the third variation of the first embodiment. Here, operations different from those of the first embodiment and its variations described above will be mainly described, and overlapping descriptions will be omitted.

In step S401, the NCR-MT 520A controls the NCR-Fwd 510A according to configuration (and control) from the gNB 200. Here, it is assumed that NCR-MT 520A controls the NCR-Fwd 510A that relays SCG (PSCell and/or SCell).

In step S402, the NCR-MT 520A receives the RRC Reconfiguration message from the gNB 200 (the MN 200M).

When the PSCell is deactivated according to the reconfiguration (step S403: YES), that is, when the configuration is changed from an active state to an inactive state, the NCR-MT 520A turns off all of the NCR-Fwds 510A that relay the SCG in step S404. The NCR-MT 520A may discard the latest NCR control signal that the NCR-MT 520A holds. Here, whether to discard the latest NCR control signal that the NCR-MT 520A holds may be instructed/configured from the gNB 200 to the NCR-MT 520A by the reconfiguration (or by prior configuration).

On the other hand, when the PSCell is activated in accordance with the reconfiguration (step S403: NO), that is, when the reconfiguration is a configuration from an inactive state to an active state, the NCR-MT 520A may restore control of the corresponding NCR-Fwd 510A according to the latest NCR control signal that the NCR-MT 520A holds in step S405. Whether to perform the control restoration may be instructed or configured from the gNB 200 to the NCR-MT 520A in the reconfiguration (or prior configuration). The NCR-MT 520A may perform the configuration restoration at a timing when an RRC Reconfiguration Complete message is transmitted, at a timing when access to the PSCell started (that is, at a timing when the RACH procedure starts), at a timing when access to the PSCell is successful (that is, at a timing when the RACH procedure is completed), or at a timing when the PSCell becomes available (data communication possible). When the reconfiguration does not include the new configuration of the NCR-Fwd 510A, the NCR-MT 520A may turn off the NCR-Fwd 510A. Alternatively, when the reconfiguration includes the new configuration of the NCR-Fwd 510A, the NCR-MT 520A may apply the new configuration of the NCR-Fwd 510A and start controlling the NCR-Fwd 510A.

### (2) Second Embodiment

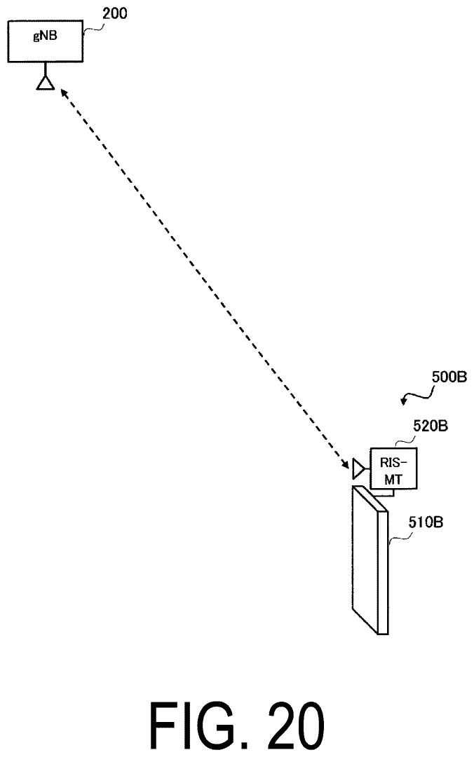

Next, a second embodiment will be described, focusing mainly on differences from the above-described embodiments. As illustrated in FIG. 20, the relay apparatus according to the second embodiment is a reconfigurable intelligent surface (RIS) apparatus 500B that changes a propagation direction of an incident radio wave (radio signal) through reflection or refraction. The “NCR” in the above-described embodiments may be read as the “RIS”.

The RIS is a type of a relay device (hereinafter, also referred to as a “RIS-Fwd”) capable of performing beamforming (directivity control) in a similar way to the NCR by changing the characteristics of metamaterials. The RIS may be able to change a range (distance) of a beam by controlling a reflection direction and/or a refraction direction of each unit element. For example, the RIS may have a configuration capable of controlling the reflection direction and/or refraction direction of each unit element, and focusing on a near UE (directing a beam) or focusing on a far UE (directing a beam).

The RIS apparatus 500B includes a new UE (hereinafter referred to as “RIS-MT”) 520B that is a control terminal for controlling RIS-Fwd 510B. The RIS-MT 520B controls the RIS-Fwd 510B in cooperation with the gNB 200 by establishing a wireless connection to the gNB 200 and performing wireless communication with the gNB 200. The RIS-Fwd 510B may be a reflective RIS. Such an RIS-Fwd 510B reflects an incident radio wave to change a propagation direction of the radio wave. Here, a reflection angle of the radio wave can be variably configured. The RIS-Fwd 510B reflects radio waves incident from the gNB 200 toward the UE 100. The RIS-Fwd 510B may be a transmissive RIS. Such an RIS-Fwd 510B refracts an incident radio wave to change the propagation direction of the radio wave. Here, a refraction angle of the radio wave can be variably configured.

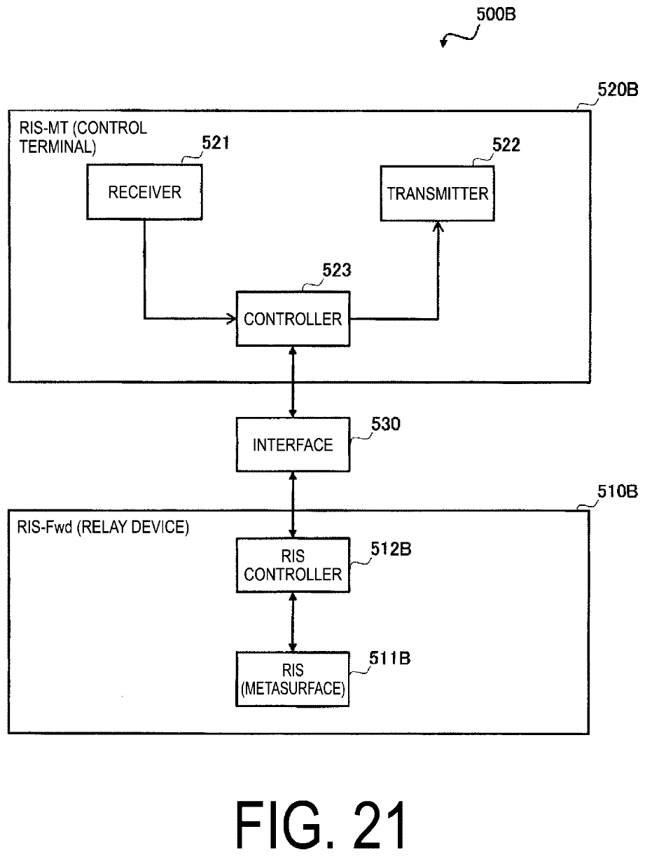

FIG. 21 is a diagram illustrating an example of a configuration of a RIS-Fwd (relay device) 510B and a RIS-MT (control terminal) 520B according to the second embodiment. The RIS-MT 520B has a receiver 521, a transmitter 522, and a controller 523. Such a configuration is the same as that of the above-described embodiment. The RIS-Fwd 510B includes a RIS 511B and a RIS controller 512B. The RIS 511B is a metasurface configured using a metamaterial. For example, RIS 511B is configured by disposing extremely small structures relative to the wavelength of radio waves in an array, and the direction and/or beam shape of the reflected waves can be arbitrarily designed by making the structures different shapes depending on their disposition location. The RIS 511B may be a transparent dynamic metasurface. The RIS 511B may be configured by stacking a transparent glass substrate on transparent version of a metasurface substrate on which a large number of small structures are regularly disposed, and may be capable of dynamically controlling three patterns of a mode of transmitting an incident radio wave, a mode of transmitting a part of a radio wave and reflecting a part thereof, and a mode of reflecting all radio waves by minutely moving the stacked glass substrate. The RIS controller 512B controls the RIS 511B in response to a RIS control signal from the controller 523 in the RIS-MT 520B. The RIS controller 512B may include at least one processor and at least one actuator. The processor interprets a RIS control signal from the controller 523 in the RIS-MT 520B to drive the actuator in response to the RIS control signal.

### (3) Other Embodiments

In the above-described embodiment, an example in which the relay apparatus performing relay transmission is the NCR apparatus 500A or a RIS apparatus 500B has been described. However, the relay apparatus that performs relay transmission is not limited to the NCR apparatus 500A or the RIS apparatus 500B, and may be an integrated access and backhaul (IAB) node defined in the technical specifications of 3GPP.

Each of the above-described operation flows is not limited to being performed separately and independently, but can be performed by combining two or more operation flows. For example, some steps of one operation flow may be added to another operation flow or some steps of one operation flow may be replaced with some steps of another operation flow. In each flow, all steps may not be necessarily performed, and only some of the steps may be performed.

In the above-described embodiment, an example in which the base station is an NR base station (gNB) has been described, but the base station may be an LTE base station (eNB). The base station may be a relay node such as an IAB node. The base station may be a distributed unit (DU) of the IAB node. Further, the UE 100 may be a mobile termination (MT) of the IAB node.

Further, the term “network node” mainly means a base station, but may also mean a core network apparatus or a part (CU, DU, or RU) of a base station. The network node may be configured by a combination of at least a part of a core network apparatus and at least a part of a base station.

A program may be provided that causes a computer to execute each process performed by the UE 100, the gNB 200, or the relay apparatus. The program may be recorded in a computer-readable medium. Use of the computer-readable medium enables the program to be installed on a computer. Here, the computer-readable medium on which the program is recorded may be a non-transitory recording medium. The non-transitory recording medium is not particularly limited, and may be, for example, a recording medium such as a CD-ROM or a DVD-ROM. Circuits for executing processing performed by the UE 100 or the gNB 200 may be integrated, and at least a part of the UE 100 and the gNB 200 may be implemented as a semiconductor integrated circuit (chipset, System on a chip (SoC)).

Functions realized by the UE 100, the gNB 200 (network node), or the relay apparatus may be implemented in circuitry or processing circuitry that includes a general-purpose processor, a special-purpose processor, an integrated circuit, an application specific integrated circuit (ASIC), a central processing unit (CPU), conventional circuit, and/or combinations thereof programmed to realize the described functions. The processor may include transistors and other circuits and may be considered as the circuitry or processing circuitry. The processor may be a programmed processor that executes a program stored in a memory. Circuitry, unit, and means herein are hardware programmed to realize the described functions, or hardware executing the functions. The hardware may be any hardware disclosed herein or any hardware programmed to realize or known to execute the described functions. When the hardware is a processor that is considered to be a type of circuitry, the circuitry, means, or unit is a combination of hardware with software used to configure the hardware and/or processor.

A program causing a computer to execute each of the processes performed by the communication apparatus according to the embodiment described above, for example, the UE 100 (NCR-MT 520A and RIS-MT 520B) or the gNB 200 may be provided. The program may be recorded in a computer-readable medium. Use of the computer-readable medium enables the program to be installed on a computer. Here, the computer-readable medium on which the program is recorded may be a non-transitory recording medium. The non-transitory recording medium is not particularly limited, and may be, for example, a recording medium such as a CD-ROM or a DVD-ROM. Circuits for executing processing performed by the UE 100 or the gNB 200 may be integrated, and at least a part of the UE 100 and the gNB 200 may be implemented as a semiconductor integrated circuit (chipset, System on a chip (SoC)).

The phrases “based on” and “depending on/in response to” used in the present disclosure do not mean “based only on” and “only depending on/in response to” unless specifically stated otherwise. The phrase “based on” means both “based only on” and “based at least in part on.” The phrase “depending on” means both “only depending on” and “at least partially depending on.” The terms “include,” “comprise” and variations thereof do not mean “include only items stated” but instead mean “may include only items stated” or “may include not only the items stated but also other items.” The term “or” used in the present disclosure is not intended to be “exclusive or.” Further, any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a,” “an,” and “the” are added in the present disclosure through translation, these articles include the plural unless clearly indicated otherwise in context.

The embodiments have been described above in detail with reference to the drawings, but specific configurations are not limited to those described above, and various design variation can be made without departing from the gist of the present disclosure.

### (4) Supplements

The features of the above-described embodiments will be supplemented.

### (Supplement 1)

A communication method used in a relay apparatus including a relay device configured to perform a relay operation of relaying a radio signal transmitted between a network and a user equipment, and a control terminal configured to receive a control signal used for control of the relay device from the network, the communication method including: receiving, by the control terminal in a radio resource control (RRC) connected state, an RRC Reconfiguration message from the network; and turning off the relay device configured to perform the relay operation for a serving cell of the control terminal, when changing or deactivating the serving cell based on the RRC Reconfiguration message.

### (Supplement 2)

The communication method according to supplement 1, further including continuing the relay operation for the serving cell, when maintaining the serving cell based on the RRC Reconfiguration message.

### (Supplement 3)

The communication method according to supplement 1 or 2, wherein the serving cell is a secondary cell (SCell) configured for the relay apparatus, and the turning off includes turning off the relay device configured to perform the relay operation for the SCell, when the SCell is changed or when the SCell is deactivated based on the RRC Reconfiguration message.

### (Supplement 4)

The communication method according to supplement 1 or 2, wherein the serving cell is a primary secondary cell (PSCell) configured for the relay apparatus, and the turning off includes turning off the relay device configured to perform the relay operation for the PSCell, when the PSCell is changed based on the RRC Reconfiguration message.

### (Supplement 5)

The communication method according to supplement 1 or 2, wherein the serving cell is a cell belonging to a secondary cell group (SCG) configured for the relay apparatus, and the turning off includes turning off the relay device configured to perform the relay operation for the serving cell belonging to the SCG, when the SCG is deactivated based on the RRC Reconfiguration message.

### (Supplement 6)

A relay apparatus including a relay device configured to perform a relay operation of relaying a radio signal transmitted between a network and a user equipment, and a control terminal configured to receive a control signal used for control of the relay device from the network, in which the control terminal: receives a radio resource control (RRC) Reconfiguration message from the network in an RRC connected state; and turns off the relay device configured to perform the relay operation for a serving cell of the control terminal, when the serving cell is changed or deactivated based on the RRC Reconfiguration message.

### REFERENCE SIGNS

1: Mobile communication system
100: UE
200: gNB
210: Transmitter
220: Receiver
230: Controller
240: Backhaul communicator
500A: NCR apparatus
510A: NCR-Fwd
520A: NCR-MT
500B: RIS apparatus
510B: RIS-Fwd
520B: RIS-MT
511A: Wireless unit
511a: Antenna
511b: RF circuit
511c: Directivity controller
512A: NCR controller
512B: RIS controller
521: Receiver
522: Transmitter
523: Controller
530: Interface

1. A communication method used in a relay apparatus comprising a relay device configured to perform a relay operation of relaying a radio signal transmitted between a network and a user equipment, and a control terminal configured to receive a control signal used for control of the relay device from the network, the communication method comprising the steps of:
receiving, by the control terminal in a radio resource control (RRC) connected state, an RRC Reconfiguration message from the network; and
turning off the relay device configured to perform the relay operation for a serving cell of the control terminal, when changing or deactivating the serving cell based on the RRC Reconfiguration message.

2. The communication method according to claim 1, further comprising continuing the relay operation for the serving cell, when maintaining the serving cell based on the RRC Reconfiguration message.

3. The communication method according to claim 1, wherein
the serving cell is a secondary cell (SCell) configured for the relay apparatus, and
the turning off comprises turning off the relay device configured to perform the relay operation for the SCell,
when the SCell is changed or when the SCell is deactivated based on the RRC Reconfiguration message, or when the SCell is deactivated based on a Medium Access Control Control Element (MAC CE).

4. The communication method according to claim 1, wherein
the serving cell is a primary secondary cell (PSCell) configured for the relay apparatus, and
the turning off comprises turning off the relay device configured to perform the relay operation for the PSCell, when the PSCell is changed based on the RRC Reconfiguration message.

5. The communication method according to claim 1, wherein
the serving cell is a cell belonging to a secondary cell group (SCG) configured for the relay apparatus, and
the controlling to turn off comprises controlling to turn off the relay device configured to perform the relay operation for the serving cell belonging to the SCG, when the SCG is deactivated based on the RRC Reconfiguration message.

6. A relay apparatus comprising:
a relay device configured to perform a relay operation of relaying a radio signal transmitted between a network and a user equipment; and
a control terminal configured to receive a control signal used for control of the relay device from the network,
wherein the control terminal:
receives a radio resource control (RRC) Reconfiguration message from the network in an RRC connected state; and
turns off the relay device configured to perform the relay operation for a serving cell of the control terminal, when the serving cell is changed or deactivated based on the RRC Reconfiguration message.
